(19) United States
(12) Patent Application Publication
(10) Pub. No.: US 2010/0036052 A1
(43) Pub. Date: Feb. 11, 2010

(54) PROCESS FOR PREPARING POLYMERS FILLED WITH NANOSCALE METAL OXIDES

(75) Inventors: Andrey Karpov, Mannheim (DE); Hartmut Hibst, Schriesheim (DE); Claudia Mettlach, Mannheim (DE); Lionel Gehringer, Scheibenhard (FR); Motonori Yamamoto, Mannheim (DE); Berend Eling, Lemfoerde (DE); Hans-Helmut Goertz, Freinsheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/513,639

(22) PCT Filed: Nov. 5, 2007
(86) PCT No.: PCT/EP2007/061876

§ 371 Date: May 5, 2009

(30) Foreign Application Priority Data
Nov. 7, 2006 (EP) 06123559.4

(51) Int. Cl. C08K 3/22; C08K 3/10; C08F 2/44

(52) U.S. Cl. 524/781; 524/779; 524/783; 524/785; 524/786; 524/780; 977/811; 977/773

(57) ABSTRACT

A process is proposed for preparing polymers filled with nanoscale metal oxides and comprises the following steps:
a) preparing a nanosuspension of one or more crystalline metal oxides, hydroxides or oxide hydroxides by heating a suspension of one or more compounds comprising the corresponding metals in a first polymerizable compound to a temperature greater than the boiling point of water under process pressure and less than the boiling temperature of the first polymerizable compound and also less than the temperature at which the polymerization of the first polymerizable compound commences,
in the presence of water in an amount corresponding to 1 to 10 oxygen atoms per metal atom of the compound or compounds comprising the corresponding metals, and
b) polymerizing the first polymerizable compound under pressure and temperature conditions typical for the first polymerizable compound.

The invention relates to a process for preparing polymers filled with nanoscale metal oxides, and to polymers prepared accordingly.

In a known way, on account of their high specific surface area, nanoscale additives give polymers a range of outstanding properties: they are highly active in particular wherever the concern is, for example, to cause them to interact, via their surface, with electromagnetic radiation from the ambient environment. Besides this, they can be distributed uniformly in other materials to a level down into the submicroscopic range, leading to a highly homogeneous profile of properties. On account of their particular fineness, not only are they invisible per se, but the materials comprising them frequently do not even exhibit any clouding, and appear transparent. Owing to quantum effects, nanoparticles often possess new and different properties than less finely divided materials of the same chemical constitution.

WO 2005/075548 describes by way of example a process for preparing polyester resins with nanoscale additives for powder coating materials, the nanoscale additives being introduced in the form of a suspension in an external liquid phase, liquid diols for example, into the resin synthesis reaction mixture.

EP-B 0 236 945 describes a process for producing a polyester film, using a glycol suspension of an amorphous inorganic oxide, the suspension being obtained by hydrolyzing a corresponding organometallic compound at a temperature in the range from 0 to 100° C., preferably between 0 and 50° C. In that case, however, comparatively expensive starting materials are employed, and amorphous particles are obtained which are unable to adequately interact with electromagnetic radiation from the ambient environment.

WO 01/72881 describes a further polyester-based composition comprising a polyester-based matrix and nanoscale mineral particles which are introduced as a glycol sol into the polyester synthesis mixture.

EP-A 1 199 389 describes a glycol reactant for polyesters, comprising dispersed superfine ceramic particles with an average grain size between 0.05 and 0.5 μm and a narrow particle size distribution, the superfine ceramic particles being obtained by a costly and inconvenient treatment of a glycol, comprising a conventional dispersed ceramic powder with a particle size between 1 and 30 μm and with a broad particle size distribution, by pulverization in an ultrasonic homogenizer or in a jet mill.

The so-called polyol route to preparing monodisperse metal oxide particles in the submicron range by heating the corresponding metal salts in polyols in the presence of hydrous sources, such as water of crystallization or free water, the salts being decomposed or hydrolyzed to form the corresponding metal oxides, is known and is described by way of example in J. of Sol-Gel Science and Technology 26, 2003, pages 261-265.

It was an object of the invention, accordingly, to provide an improved process for preparing polymers filled with nanoscale metal oxides that ensures, in particular, a further improvement in the equal distribution of the nanoscale metal oxides in the polymer matrix, and correspondingly improved properties with respect to interaction with electromagnetic radiation and to mechanical, rheological, and antimicrobial properties, and also an increased efficiency.

Furthermore, improved dispersing properties with lower energy consumption as compared with the prior art are achieved, leading to lower preparation costs. As a result of the high homogeneity of distribution, an improved action is achieved for lower input, i.e., an increased efficiency over known processes.

The solution consists in a process for preparing polymers filled with nanoscale metal oxides and comprises the following steps:
a) preparing a nanosuspension of one or more crystalline metal oxides, hydroxides or oxide hydroxides by heating a suspension of one or more compounds comprising the corresponding metals in a first polymerizable compound to a temperature greater than the boiling point of water under process pressure and less than the boiling temperature of the first polymerizable compound and also less than the temperature at which the polymerization of the first polymerizable compound commences,
in the presence of water in an amount corresponding to 1 to 10 oxygen atoms per metal atom of the compound or compounds comprising the corresponding metals, and

b) polymerizing the first polymerizable compound under pressure and temperature conditions typical for the first polymerizable compound.

In accordance with the invention, in a first process step a), a nanosuspension comprising one or more crystalline metal oxides, oxide hydrides or hydroxides is prepared by heating a suspension of one or more compounds of the corresponding metals in the presence of water in a first polymerizable compound.

First polymerizable compound for the present purposes also comprehends a mixture of polymerizable compounds.

Accordingly, one or more metallic compounds are the starting point, preferably one salt or two or more salts of metals, which in step a) are converted into the corresponding oxide hydroxide, hydroxide or oxide, preferably into the corresponding oxide.

These compounds may in particular be salts of monocarboxylic acids, such as formic acid, acetic acid, propionic acid, acid, isobutyric acid, caproic acid, caprylic acid, lauric acid, myristic acid, palmitic acid, and stearic acid, unsaturated fatty acids, such as acrylic acid, methacrylic acid, crotonic acid, oleic acid, and linolenic acid, saturated polybasic carboxylic acids, such as oxalic acid, malonic acid, succinic acid, adipic acid, suberic acid, and β,β-dimethylglutaric acid, unsaturated polybasic carboxylic acids, such as maleic acid and fumaric acid, saturated alicyclic acids, such as cyclohexane-carboxylic acid, aromatic carboxylic acids, such as the aromatic monocarboxylic acids, especially phenylacetic acid and toluic acid, and unsaturated polybasic carboxylic acids, such as phthalic acid, isophthalic acid, terephthalic acid, pyromellitic acid, and trimellitic acid, compounds containing functional groups, such as OH groups, amino group, nitro groups, alkoxy groups, sulfone groups, cyano groups, and halogen atoms in the molecule, as well as a carboxyl group, such as trifluoroacetic acid, ortho-chlorobenzoic acid, ortho-nitrobenzoic acid, anthranilic acid, para-aminobenzoic acid, para-chlorobenzoic acid, toluic acid, lactic acid, salicylic acid, and polymers comprising at least one of the aforementioned unsaturated acids in the form of a polymerizable compound, such as acrylic acid homopolymers and acrylic acid/methylmethacrylate copolymers.

As salt or as salts there are used one or more salts of monocarboxylic acids, especially of formic acid, acetic acid, propionic acid, stearic acid, acrylic acid and/or oleic acid and/or one or more salts of dicarboxylic acids, especially of oxalic acid, adipic acid, isophthalic acid and/or terephthalic acid.

The metal component used in the salts may be, for example, zinc, titanium, cerium, zirconium, iron, cobalt, copper, aluminum or manganese, or mixtures of these.

As first polymerizable compound, which may also be a mixture, it is possible in particular to use one or more substances selected from the following list: styrene, caprolactam or an acrylate.

Where one of the abovementioned substances is used as first polymerizable compound, the process of the invention is preferably carried out such that first of all the nanosuspension of one or more crystalline metal oxides, oxide hydroxides or hydroxides in the first polymerizable compound is prepared in step a) and in step b) this nanosuspension is polymerized under the pressure and temperature conditions typical for the first polymerizable compound. In this case the addition of a further polymerizable compound is not necessary. In one embodiment a further amount of the same compound prepared in step a) is added during the polymerization in step b).

In a further preferred embodiment a diol or a diol derivative, in particular a diol ether or a diol ester, is used as first polymerizable compound in step a).

Diol compounds used include, in particular, branched or linear alkanediols having 2 to 18 carbon atoms, preferably 4 to 14 carbon atoms, cycloalkanols having 5 to 20 carbon atoms, or aromatic diols.

Examples of suitable alkanediols are ethylene glycol, 1,2-propanediol, 1,3-propanediol, 1,2-butanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 2,4-dimethyl-2-ethyl-1,3-hexanediol, 2,2-dimethyl-1,3-propanediol (neopentyl glycol), 2-ethyl-2-butyl-1,3-propanediol, 2-ethyl-2-isobutyl-1,3-propanediol or 2,2,4-trimethyl-1,6-hexanediol. Particular suitability is possessed by ethylene glycol, 1,3-propanediol, 1,4-butanediol, and 2,2-dimethyl-1,3-propanediol, 1,6-hexanediol or 1,12-dodecanediol.

Examples of cycloalkanediols are 1,2-cyclopentanediol, 1,3-cyclopentanediol, 1,2-cyclohexanediol, 1,3-cyclohexanediol, 1,4-cyclohexanediol, 1,2-cyclohexanedimethanol (1,2-dimethylolcyclohexane), 1,3-cyclohexanedimethanol (1,3-dimethylolcyclohexane), 1,4-cyclohexanedimethanol (1,4-dimethylolcyclohexane) or 2,2,4,4-tetramethyl-1,3-cyclobutanediol.

Examples of suitable aromatic diols are 1,4-dihydroxybenzene, 1,3-dihydroxybenzene, 1,2-dihydroxybenzene, bisphenol A (2,2-bis(4-hydroxyphenyl)propane), 1,3-dihydroxynaphthalene, 1,5-dihydroxynaphthalene or 1,7-dihydroxynaphthalene.

As diol compounds it is also possible, however, to use polyetherdiols, examples being diethylene glycol, triethylene glycol, polyethylene glycol (with ≧4 ethylene oxide units), propylene glycol, dipropylene glycol, tripropylene glycol, polypropylene glycol (with ≧4 propylene oxide units), and polytetrahydrofuran (polyTHF), especially diethylene glycol, triethylene glycol, and polyethylene glycol (with ≧4 ethylene oxide units). For polyTHF, polyethylene glycol or polypropylene glycol, compounds are used whose number-average molecular weight (Mₙ) is generally in the range from 50 to 100 000, preferably from 200 to 10 000, more preferably from 600 to 5000 g/mol.

It is of course also possible to use mixtures of aforementioned diol compounds.

Where a diol compound is used as first polymerizable compound, the polymerization in step b) is carried out with the addition of a second polymerizable compound, which in particular may be a dicarboxylic acid compound, a dicarboxylic ester compound, a diamino compound, a hydroxycarboxylic acid compound, an aminoalcohol compound, an aminocarboxylic acid compound or a further compound which has at least three hydroxy-primary or -secondary amino and/or carboxyl groups per molecule, aliphatic or aromatic diisocyanates, or else mixtures of aforementioned compounds.

As dicarboxylic acid compounds it is possible in principle to use all C₂-C₄₀ aliphatic, C₃-C₂₀ cycloaliphatic, aromatic or heteroaromatic compounds which contain two carboxylic acid groups (carboxyl groups; —COOH) or derivatives thereof. Derivatives used include, in particular, C₁-C₁₀ alkyl, preferably methyl, ethyl, n-propyl or isopropyl, monoesters or diesters of aforementioned dicarboxylic acids, the corresponding dicarbonyl halides, especially the dicarbonyl dichlorides, and the corresponding dicarboxylic anhydrides. Examples of compounds of this kind are ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid (brassylic acid), C₃₂ dimer fatty acid (commercial product of Cognis Corp., USA), benzene-1,2-dicarboxylic acid (phthalic acid), benzene-1,3-dicarboxylic acid (isophthalic acid) or benzene-1,4-dicarboxylic acid (terephthalic acid), their methyl esters, such as dimethyl ethanedioate, dimethyl propanoate, dimethyl butanedioate, dimethyl pentanedioate, dimethyl hexanedioate, dimethyl heptanedioate, dimethyl octanedioate, dimethyl nonanedioate, dimethyl decanedioate, dimethyl undecanedioate, dimethyl dodecanedioate, dimethyl tridecanedioate, C₃₂ dimer fatty acid dimethyl ester, dimethyl phthalate, dimethyl isophthalate or dimethyl terephthalate, their dichlorides, such as ethanoyl dichloride, propanedioyl dichloride, butanedioyl dichloride, pentanedioyl dichloride, hexanedioyl dichloride, heptanedioyl dichloride, octanedioyl dichloride, nonanedioyl dichloride, decanedioyl dichloride, undecanedioyl dichloride, dodecanedioyl dichloride, tridecanedioyl dichloride, C₃₂ dimer fatty acid dichloride, phthaloyl dichloride, isophthaloyl dichloride or terephthaloyl dichloride, and also their anhydrides, examples being butanedicarboxylic, pentanedicarboxylic or phthalic anhydride. It is of course also possible to use mixtures of aforementioned dicarboxylic acid compounds.

Suitable diamine compounds include all organic diamine compounds which contain two primary or secondary amino groups, primary amino groups being preferred. The organic skeleton containing the two amino groups may have a C₂-C₂₀ aliphatic, C₃-C₂₀ cycloaliphatic, aromatic or heteroaromatic structure. Examples of compounds containing two primary amino groups are 1,2-diaminoethane, 1,3-diaminopropane, 1,2-diaminopropane, 2-methyl-1,3-diaminopropane, 2,2-dimethyl-1,3-diaminopropane (neopentyldiamine), 1,4-diaminobutane, 1,2-diaminobutane, 1,3-diaminobutane, 1-methyl-1,4-diaminobutane, 2-methyl-1,4-diaminobutane, 2,2-dimethyl-1,4-diaminobutane, 2,3-dimethyl-1,4-diaminobutane, 1,5-diaminopentane, 1,2-diaminopentane, 1,3-diaminopentane, 1,4-diaminopentane, 2-methyl-1,5-diaminopentane, 3-methyl-1,5-diaminopentane, 2,2-dimethyl-1,5-diaminopentane, 2,3-dimethyl-1,5-diaminopentane, 2,4-dimethyl-1,5-diaminopentane, 1,6-diaminohexane, 1,2-diaminohexane, 1,3-diaminohexane, 1,4-diaminohexane, 1,5-diaminohexane, 2-methyl-1,5-diaminohexane, 3-methyl-1,5-diaminohexane, 2,2-dimethyl-1,5-diaminohexane, 2,3-dimethyl-1,5-diaminohexane, 3,3-dimethyl-1,5-diaminohexane, N,N′-dimethyl-1,6-diaminohexane, 1,7-diaminoheptane, 1,8-diaminooctane, 1,9-diaminononane, 1,10-diaminodecane, 1,11-diaminoundecane, 1,12-diaminododecane, 1,2-diaminocyclohexane, 1,3-diaminocyclohexane, 1,4-diaminocyclohexane, 3,3′-diaminodicyclohexylmethane, 4,4′-diaminodicyclohexylmethane (dicyan), 3,3′-dimethyl-4,4′-diaminodicyclohexylmethane (Laromin®), isophoronediamine (3-aminomethyl-3,5,5-trimethylcyclohexylamine), 1,4-diazine (piperazine), 1,2-diaminobenzene, 1,3-diaminobenzene, 1,4-diaminobenzene, m-xylylenediamine [1,3-(diaminomethyl)benzene], and p-xylylenediamine [1,4-(diaminomethyl)benzene]. It is of course also possible to use mixtures of aforementioned compounds.

Preference is given to using 1,6-diaminohexane, 1,12-diaminododecane, 2,2-dimethyl-1,3-diaminopropane, 1,4-diaminocyclohexane, isophoronediamine, 3,3′-diaminodicyclohexylmethane, 4,4′-diaminodicyclohexylmethane, 3,3′-dimethyl-4,4′-diaminodicyclohexylmethane, m-xylylenediamine or p-xylylenediamine as optional diamine compounds.

As hydroxycarboxylic acid compounds it is possible to use the free hydroxycarboxylic acids, their C₁-C₅ alkyl esters and/or their lactones. Mention may be made, by way of example, of glycolic acid, D-, L-, D,L-lactic acid, 6-hydroxyhexanoic acid (6-hydroxycaproic acid), 3-hydroxybutyric acid, 3-hydroxyvaleric acid, 3-hydroxycaproic acid, p-hydroxybenzoic acid, their cyclic derivatives such as glycolide (1,4-dioxane-2,5-dione), D-, L-, D,L-dilactide (3,6-dimethyl-1,4-dioxane-2,5-dione), ε-caprolactone, β-butyrolactone, γ-butyrolactone, dodecanolide (oxacyclotridecan-2-one), undecanolide (oxacyclododecan-2-one) or pentadecanolide (oxacyclohexadecan-2-one). It is of course also possible to use mixtures of different hydroxycarboxylic acid compounds.

As aminoalcohol compounds it is possible in principle to use all, but preferably C₂-C₁₂ aliphatic, C₅-C₁₀ cycloaliphatic or aromatic organic compounds which contain only one hydroxyl group and one secondary or primary, but preferably one primary, amino group. Mention may be made, by way of example, of 2-aminoethanol, 3-aminopropanol, 4-aminobutanol, 5-aminopentanol, 6-aminohexanol, 2-aminocyclopentanol, 3-aminocyclopentanol, 2-aminocyclohexanol, 3-aminocyclohexanol, 4-aminocyclohexanol, and 4-aminomethylcyclohexanemethanol (1-methylol-4-aminomethylcyclohexane). It is of course also possible to use mixtures of the aforementioned aminoalcohol compounds.

Suitable aminocarboxylic acid compounds include all organic compounds which contain an amino group and a carboxyl group in free or derivatized form, but particularly the C₂-C₃₀ aminocarboxylic acids, the C₁-C₅ alkyl esters of aforementioned aminocarboxylic acids, the corresponding C₃-C₁₅ lactam compounds, the C₂-C₃₀ aminocarboxamides or the C₂-C₃₀ aminocarbonitriles. Mention of the free C₂-C₃₀ aminocarboxylic acids may be made, by way of example, of the naturally occurring aminocarboxylic acids, such as valine, leucine, isoleucine, threonine, methionine, phenylalanine, tryptophan, lysine, alanine, arginine, aspartic acid, cysteine, glutaminic acid, glycine, histidine, proline, serine, tyrosine, asparagine or glutamine, and also 3-aminopropionic acid, 4-aminobutyric acid, 5-aminovaleric acid, 6-aminocaproic acid, 7-aminoenanthic acid, 8-aminocaprylic acid, 9-aminopelargonic acid, 10-aminocapric acid, 11-aminoundecanoic acid, 12-aminolauric acid, 13-aminotridecanoic acid, 14-aminotetradecanoic acid or 15-aminopentadecanoic acid. Mention of the C₁-C₅ alkyl esters of the aforementioned aminocarboxylic acids may be made, by way of example, of the methyl and ethyl esters of 3-aminopropionic acid, 4-aminobutyric acid, 5-aminovaleric acid, 6-aminocaproic acid, 7-aminoenanthic acid, 8-aminocaprylic acid, 9-aminopelargonic acid, 10-aminocapric acid, 11-aminoundecanoic acid, 12-aminolauric acid, 13-aminotridecanoic acid, 14-aminotetradecanoic acid or 15-aminopentadecanoic acid. Examples that may be mentioned of the C₃-C₁₅ lactam compounds include β-propiolactam, γ-butyrolactam, δ-valerolactam, ε-caprolactam, 7-enantholactam, 8-caprylollactam, 9-pelargolactam, 10-caprilactam, 11-undecanolactam, ω-laurolactam, 13-tridecanolactam, 14-tetradecanolactam or 15-pentadecanolactam. Examples that may be mentioned of the aminocarboxamides include 3-aminopropionamide, 4-aminobutyramide, 5-aminovaleramide, 6-aminocaproamide, 7-aminoenanthamide, 8-aminocaprylamide, 9-aminopelargonamide, 10-aminocapramide, 11-aminoundecanamide, 12-aminolauramide, 13-aminotridecanamide, 14-aminotetradecanamide or 15-aminopentadecanamide, and examples that may be mentioned of the aminocarbonitriles include 3-aminopropionitrile, 4-aminobutyronitrile, 5-aminovaleronitrile, 6-aminocapronitrile, 7-aminoenanthonitrile, 8-aminocaprylonitrile, 9-aminopelargononitrile, 10-aminocaprinitrile, 11-aminoundecanonitrile, 12-aminolauronitrile, 13-aminotridecanonitrile, 14-aminotetradecanonitrile or 15-aminopentadecanonitrile. Preference is given, however, to the C₃-C₁₅ lactam compounds, and of these, in particular, to ε-caprolactam and ω-laurolactam. ε-Caprolactam is particularly preferred. It is of course also possible to use mixtures of aforementioned aminocarboxylic acid compounds.

Further components which can be used in the process of the invention include organic compounds which contain at least 3 hydroxyl, primary or secondary amino and/or carboxyl groups per molecule. By way of example mention may be made of tartaric acid, citric acid, malic acid, trimethylolpropane, trimethylolethane, pentaerythritol, polyethertriols, glycerol, sugars (for example, glucose, mannose, fructose, galactose, glucosamine, sucrose, lactose, trehalose, maltose, cellobiose, gentianose, kestose, maltotriose, raffinose, trimesic acid (1,3,5-benzenetricarboxylic acid and its esters or anhydrides), trimellitic acid (1,2,4-benzenetricarboxylic acid and its esters or anhydrides), pyromellitic acid (1,2,4,5-benzenetetracarboxylic acid and its esters or anhydrides), 4-hydroxyisophthalic acid, diethylenetriamine, dipropylenetriamine, bishexamethylenetriamine, N,N′-bis(3-aminopropyl)ethylenediamine, diethanolamine or triethanolamine. By virtue of their at least 3 hydroxyl, primary or secondary amino and/or carboxyl groups per molecule, aforementioned compounds are capable of being incorporated at the same time into at least 2 polyamide chains, the resulting compound thus having a branching or crosslinking action in the context of polyamide formation. The higher the amount of compounds, or the greater the number of amino, hydroxyl and/or carboxyl groups present per molecule, the higher the degree of branching/crosslinking on polyamide formation. It is of course also possible here to use mixtures of compounds.

Aromatic diisocyanates comprehend, in particular, tolylene 2,4-diisocyanate, tolylene 2,6-diisocyanate, 2,2′-diphenylmethane diisocyanate, 2,4′-diphenylmethane diisocyanate, 4,4′-diphenylmethane diisocyanate, naphthylene 1,5-diisocyanate or xylylene diisocyanate.

Of these, 2,2′-, 2,4′-, and 4,4′-diphenylmethane diisocyanate are particularly preferred. Generally speaking, the latter diisocyanates are used as a mixture.

Tri(4-isocyanophenyl)methane, as a trinuclear isocyanate, is also suitable. The polynuclear aromatic diisocyanates are obtained, for example, when mono- or dinuclear diisocyanates are being prepared.

Aliphatic diisocyanates comprehend for the purposes of the present invention, and in particular, linear or branched alkylene diisocyanates or cycloalkylene diisocyanates having 2 to 20 carbon atoms, preferably 3 to 12 carbon atoms, examples being 1,6-hexamethylene diisocyanate, isophorone diisocyanate or methylenebis(4-isocyanatocyclohexane). Particularly preferred aliphatic diisocyanates are 1,6-hexamethylene diisocyanate and isophorone diisocyanate.

The preferred isocyanurates include the aliphatic isocyanurates which derive from alkylene diisocyanates or cycloalkylene diisocyanates having 2 to 20 carbon atoms, preferably 3 to 12 carbon atoms, such as isophorone diisocyanate or methylenebis (4-isocyanatocyclohexane), for example. These alkylene diisocyanates may be either linear or branched. Particular preference is given to isocyanurates based on n-hexamethylene diisocyanate, examples being cyclic trimers, pentamers or higher oligomers of n-hexamethylene diisocyanate.

A particularly preferred diol used is 1,4-butanediol, 1,2-ethanediol, 1,2-propanediol or 1,3-propanediol, or a mixture thereof, with further preference 1,4-butanediol.

Particularly preferred dicarboxylic acids are adipic acid and terephthalic acid.

Particularly preferred as dicarboxylic esters are dimethyl or diethyl adipate or dimethyl or diethyl terephthalate.

Very particular preference is given to combinations of the abovementioned dicarboxylic acids or dicarboxylic esters in each case with 1,4-butanediol.

In stage a) of the process a nanosuspension of one or more metal oxides, oxide hydroxides or hydroxides in crystalline form is obtained; for this purpose it is necessary for the above-described suspension of one or more compounds of the corresponding metals to be heated, in a first polymerizable compound, to a temperature which is above the boiling point of water under the process pressure in step a) and below the temperature of the boiling point of the first polymerizable compound and also below the temperature at which the polymerization of the first polymerizable compound commences. The process pressure in stage a) is preferably atmospheric pressure, although it is also possible to operate at a pressure in the range from 10⁻³ mbar to 100 kbar, preferably at a pressure in a range from 10⁻³ bar to 10² bar, more preferably at a pressure in the range from 1 to 100 bar.

The reaction in stage a) takes place in the presence of water, which may be free water or else water of crystallization, in an amount corresponding to 1 to 10 oxygen atoms per metal atom of the salt or salts of the metals corresponding to the metal oxides, preferably 2 to 4 oxygen atoms per metal atom, and more preferably 2 oxygen atoms per metal atom.

The ratio of the one or more salts employed in stage a) to the first polymerizable compound is preferably set such that the resulting nanosuspension comprises a metal oxide concentration of <50%, preferably <20%, and in particular <10% by weight, based on the total weight of the nanosuspension.

The nanosuspension obtained in stage a) has in particular an average particle size in the range from 1 to 500 nm, more preferably from 5 to 150 nm.

It may be necessary to separate off secondary components that might disrupt the polymerization from the nanosuspension prepared in stage a), before the polymerization is carried out in step b), such separation being accomplished, for example, by means of distillation, adsorption, filtration or washing. If operation in stage a) takes place under subatmospheric pressure, the secondary components can also be removed by stripping.

The temperature profile in stage a) can be arbitrary, although rapid heating rates and shorter heating times lead to smaller particles. Preferred heating rates are between 200° C./second and 800° C./hour, more preferably between 200° C./minute and 200° C./hour. Preferred heating times are between 1 minute and 24 hours, more preferably between 1 minute and 1 hour.

In a preferred embodiment, the polymers filled with nanoscalic metal oxides are crystalline.

In a further preferred embodiment, the polymers filled with nanoscalic metal oxides are amorphous.

The polymers filled with nanoscalic metal oxides obtained by the process of the invention can be preferably used as precursors for producing polyurethanes filled with crystalline nanoscalic metal oxides.

The invention is illustrated below with reference to working examples and also to a drawing:

In the drawing, specifically:

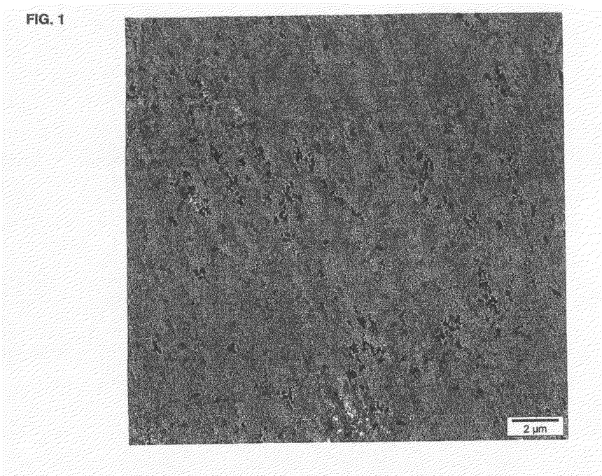

FIG. 1 shows the transmission electron micrograph (TEM) of polybutylene terephthalate filled with ZnO particles, prepared in accordance with example 1, described below;

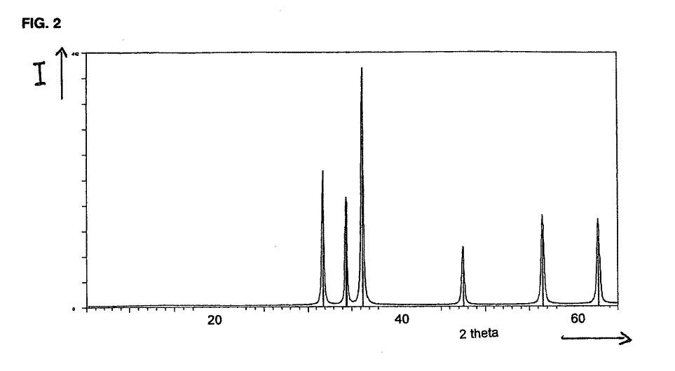

FIG. 2 shows an X-ray diffractogram of the zinc oxide powder, prepared in accordance with the comparative example described below, with, as standard, 2 theta being plotted on the abscissa and the intensity, I, on the ordinate;

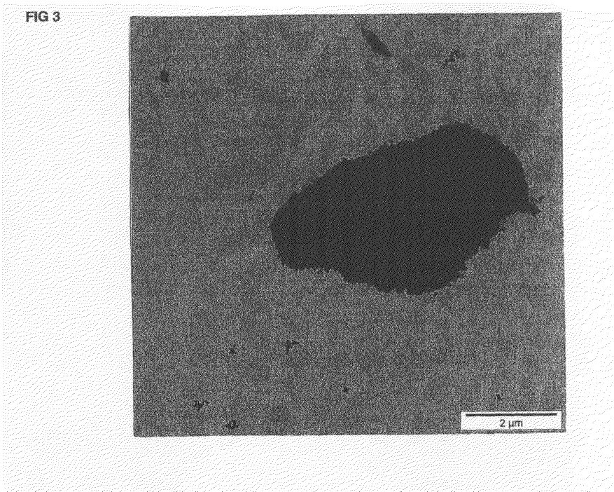

FIG. 3 shows a TEM micrograph of the ZnO-filled polybutylene terephthalate prepared in accordance with the comparative example;

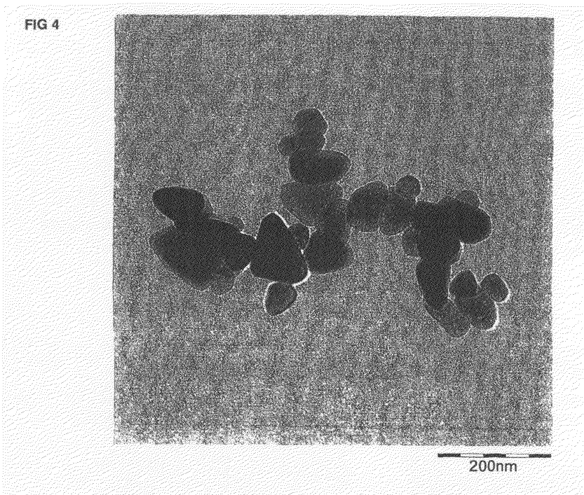

FIG. 4 shows a TEM micrograph of the ZnO suspension in 1,4-butanediol, prepared in accordance with example 2, described below, step a);

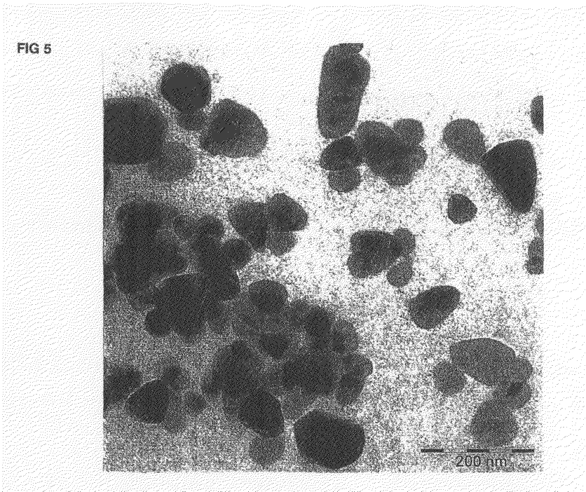

FIG. 5 shows a TEM micrograph of the ZnO-filled polybutylene adipate, prepared in accordance with example 2, described below, step b);

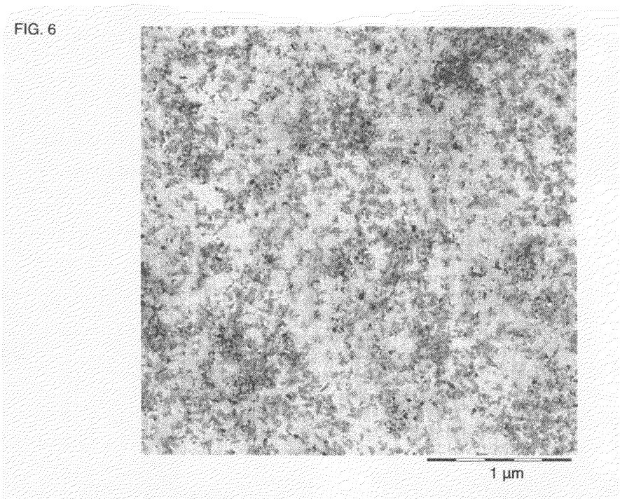

FIG. 6 shows a TEM micrograph of the ZnO-filled polybutylene adipate, prepared in accordance with example 3, described below;

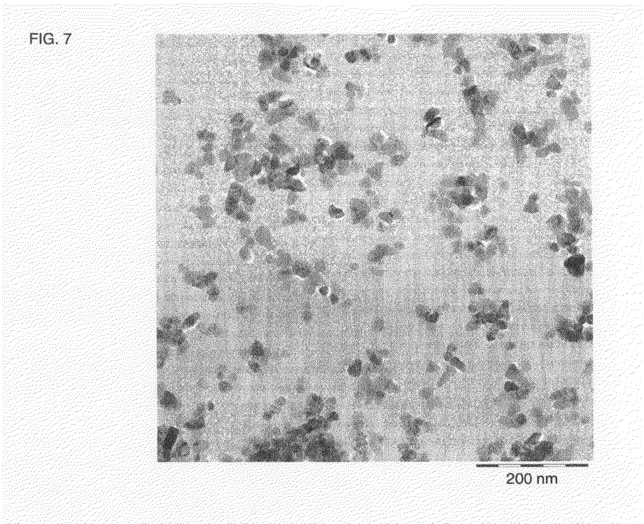

FIG. 7 shows a TEM micrograph of the ZnO-filled polybutylene adipate, prepared in accordance with example 3, with a higher resolution compared to the representation in FIG. 6, described below;

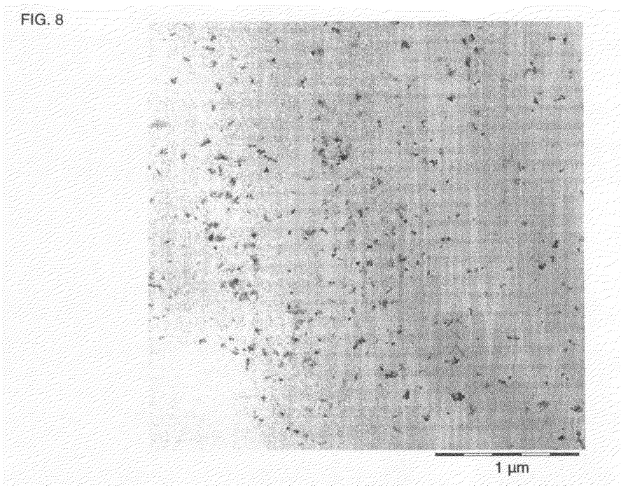

FIG. 8 shows a TEM micrograph of the ZnO-filled polyesterol, prepared in accordance with example 4, described below, step b);

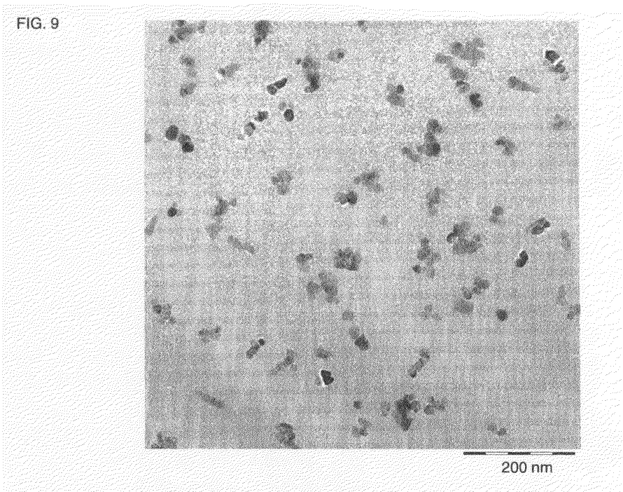

FIG. 9 shows a TEM micrograph of the ZnO-filled polyesterol, prepared in accordance with example 4, with higher resolution compared the representation in FIG. 8, described below, step b);

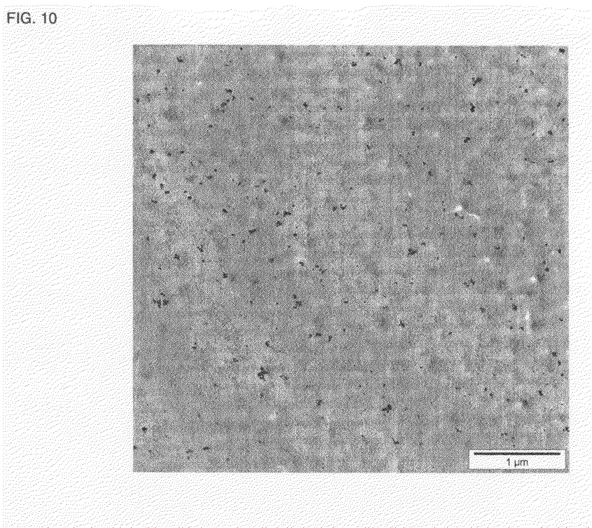

FIG. 10 shows a TEM micrograph of the ZnO-filled polypropylene terephthalate, prepared in accordance with example 5, described below, step b).

### EXAMPLE 1

Process Step a)

Preparation of a Nanosuspension of ZnO in 1,4-Butanediol

A mixture of 100 g of Zn acetate dihydrate and 1000 g of 1,4-butanediol was heated to 100° C. over the course of 15 minutes in air. Zn acetate dihydrate at the concentration used dissolved completely in 1,4-butanediol. After 100° C. had been reached, 20 ml of H₂O were added, and the mixture was heated to 150° C. and heated at that temperature for 1 hour. In a laboratory crossflow ultrafiltration unit (from Sartorius, model SF Alpha, PES cassette, cutoff 100 kD) the liquid fraction of the resulting suspension was replaced by pure 1,4-butanediol and the fraction of zinc oxide was increased to 4.85% by weight by concentration of the suspension.

For the purpose of characterization of the ZnO particles, a portion of the suspension was redispersed in ethanol and characterized by means of transmission electron microscopy (TEM). In the TEM micrograph the resulting powder had an average particle size of 50 to 80 nm. A further portion of the suspension was redispersed in ethanol and dried in a drying cabinet at 50° C. Calculation from the half-height width of the X-ray reflections gave a crystal size of between 50 nm [for the (110) reflection] and 70 nm [for the (002) reflection].

Process Step b)

Polycondensation of the ZnO Nanosuspension Prepared in Step a) with Dimethyl Terephthalate

A 250 ml flask was charged with 61.6 g of the ZnO suspension prepared in step a), and 0.08 ml of tetrabutyl orthotitanate and 97.1 g of dimethyl terephthalate were added. In a first step the mixture was heated to 180° C. over the course of 20 minutes under reflux and was heated at this temperature for 30 minutes. Thereafter the mixture was heated over the course of 70 minutes to 250° C., the pressure being reduced to a level <1 mbar. The mixture was heated in vacuo at 250° C. for 50 minutes, in the course of which the water and methanol evolved were removed completely by distillation. TEM confirmed that the ZnO particles from the nanosuspension employed have retained their size and habit and were well distributed in the polymer matrix (FIG. 1). As is apparent from FIG. 1, the ZnO particles were not larger than about 0.5 μm.

### Comparative Example

Process Step a)

Preparation of Nanoparticulate ZnO Powder

A mixture of 100 g of Zn acetate dihydrate and 1000 g of 1,4-butanediol was heated to 100° C. over the course of 15 minutes in air with stirring (350 rpm). After 100° C. had been reached, 20 ml of H₂O were added, and the mixture was heated to 150° C., heated at that temperature for 1 hour, and then cooled to room temperature. The resulting suspension was centrifuged at 13 000 rpm in a ThermoElektron Sorvall RC6 centrifuge. The sedimented ZnO powder was separated from 1,4-butanediol, redispersed twice in ethanol, and then dried in a drying cabinet at 50° C. for 5 hours.

The X-ray diffractogram of the powder obtained confirmed the formation of crystalline ZnO (FIG. 2). Calculation from the half-height width of the X-ray reflections gave an average crystal size for the primary particles of 40 nm. The ZnO powder showed an agglomerated microstructure with agglomerates in the micrometer range.

Process Step b)

Polycondensation of the ZnO Powder Prepared in Step a) with 1,4-Butanediol and Dimethyl Terephthalate

A 250 ml flask was charged with 58.6 g of 1,4-butanediol. 3.0 g of ZnO powder, prepared according to step a), were stirred into the 1,4-butanediol. The resulting 4.87% by weight suspension of ZnO in 1,4-butanediol was admixed with 0.89 ml of tetrabutyl orthotitanate and 97.1 g of dimethyl terephthalate. The mixture was heated to 250° C., in the same way as in step b) of example 1, and was heated at that temperature for 50 minutes. TEM analysis (FIG. 3) of the ZnO-filled polybutylene terephthalate obtained confirms the presence of substantially larger ZnO agglomerates than in example 1, in the range from about 2 to 6 μm.

### EXAMPLE 2

Process Step a)

Preparation of a Nanosuspension of ZnO in 1,4-Butanediol

A mixture of 100 g of Zn acetate dihydrate and 1000 g of 1,4-butanediol was heated to 100° C. over the course of 15 minutes in air. After 100° C. had been reached, 20 ml of H₂O were added and the mixture was heated to 150° C. and heated at that temperature for 1 hour. In a laboratory crossflow ultrafiltration unit from Sartorius, model SF Alpha, PES cassette, cutoff 100 kD, the liquid fraction of the resulting suspension was replaced by pure 1,4-butanediol. Subsequently the suspension obtained was concentrated to a ZnO content of 16.5% by weight.

For the purpose of characterization of the ZnO particles, a portion of the suspension was redispersed in ethanol and characterized by means of transmission electron microscopy (TEM). According to the TEM analyses, the ZnO particles obtained had average diameters of approximately 80 nm (FIG. 4).

Process Step b)

Polycondensation of the Nanosuspension Prepared in Step a) with Diethyl Adipate

A 500 ml flask was charged with 112.78 g of the ZnO suspension prepared in step a), and 289.37 g of diethyl adipate and 44.68 g of 1,4-butanediol were added with stirring. The mixture was heated to 140° C. and heated at that temperature for 7 hours. Ethanol formed was removed by distillation in the course of this heating. Thereafter 5 ppm of tetrabutyl orthotitanate were added. The pressure was reduced to a level <1 mbar and the mixture was heated at 140° C. for a further 17 hours. TEM confirmed that the ZnO particles from the nanosuspension employed have retained their size (particle size up to about 500 nm) and habit and were well distributed in the polymer matrix (FIG. 5).

### EXAMPLE 3

Process Step a)

Preparation of a Nanosuspension of ZnO in 1,4-Butanediol and Ethylene Glycol

A mixture of 100 g of Zn acetate dehydrate, 500 g of 1,4-butanediol and 500 g ethylene glycol was heated to 100° C. over the course of 15 minutes in air. After 100° C. had been reached, 20 ml of H₂O were added, the mixture was heated to 150° C. and heated at that temperature for 30 minutes under reflux and additional 30 minutes without reflux. In a laboratory crossflow ultrafiltration unit type SF Alpha, PES cassette, cutoff 100 kD, from Sartorius, the liquid fraction of the resulting suspension was replaced by a pure mixture of 1,4-butanediol and ethylene glycol (weight relation 1,4-butanediol/ethyleneglycol=1/1). Subsequently the suspension obtained was concentrated to a ZnO content of 4.6% by weight.

For the purpose of characterization of the ZnO particles, a portion of the suspension was redispersed in ethanol and characterized by means of transmission electron microscopy (TEM). According to the TEM image, the powder obtained showed an average particle size of 20-40 nm. A further portion of the suspension was redispersed in ethanol and dried in a drying cabinet at 50° C. Calculations from the half-height width of the X-ray reflections give a crystal size between 20 nm [for the (110)-reflex] and 34 nm [for the (002)-reflex].

Process Step b)

Polycondensation of the Nanosuspension Prepared in Step a) with Diethyl Adipate

A 4 l flask was charged with 803.5 g of the suspension prepared in process step a), 2298 g diethyl adipate and 175 g 1,4-butanediol were added with stirring. Afterwards 10 ppm tetrabutyl orthotitanate were added and the mixture was heated under normal pressure to 150° C. and kept for 20 hours at this temperature. Afterwards the pressure was reduced to 100 mbar and the mixture was kept for three days at 150° C. in a vacuum. By TEM the presence of homogenous dispersed, nanoparticular ZnO-particles in the product obtained was confirmed (FIG. 6, 7).

### EXAMPLE 4

Process Step a)

Preparation of a Nanosuspension of ZnO in a Mixture of 1,4-Butanediol and Ethylene Glycol

A mixture of 100 g of Zn acetate dehydrate, 500 g of 1,4-butanediol and 500 g ethylene glycol was heated to 100° C. over the course of 15 minutes in air. After 100° C. had been reached, 20 ml of H₂O were added, the mixture was heated to 150° C. and heated at that temperature for 30 minutes under reflux and additional 30 minutes without reflux. In a laboratory crossflow ultrafiltration unit type SF Alpha, PES cassette, cutoff 100 kD, from Sartorius, the liquid fraction of the resulting suspension was replaced by a pure mixture of 1,4-butanediol and ethylene glycol (weight relation 1,4-butanediol/ethyleneglycol=1/1). Subsequently the suspension obtained was concentrated to a ZnO content of 4.6% by weight.

For the purpose of characterization of the ZnO particles, a portion of the suspension was redispersed in ethanol and characterized by means of transmission electron microscopy (TEM). According to the TEM image, the powder obtained showed an average particle size of 20-40 nm. A further portion of the suspension was redispersed in ethanol and dried in a drying cabinet at 50° C. Calculations from the half-height width of the X-ray reflections give a crystal size between 20 nm [for the (110)-reflex] and 34 nm [for the (002)-reflex].

Process Step b)

Polycondensation of the Nanosuspension Prepared in Step a) with Diethyl Adipate

A 4 l flask was charged with 803.5 g of the suspension prepared in process step a), 2298 g diethyl adipate and 175 g 1,4-butanediol were added with stirring. Afterwards 10 ppm tetrabutyl orthotitanate were added and the mixture was heated under normal pressure to 150° C. and kept for 20 hours at this temperature. Afterwards the pressure was reduced to 100 mbar and the mixture was kept for three days at 150° C. in a vacuum. By TEM the presence of homogenous dispersed, nanoparticular ZnO-particles in the product obtained was confirmed (FIG. 6, 7).

### EXAMPLE 5

Preparation of a Nanosuspension of ZnO in 1,2-Propenediol

A mixture of 100 g of Zn acetate dihydrate and 1000 g of 1,4-butanediol was heated to 100° C. over the course of 15 minutes in air with stirring (350 rpm). After 100° C. had been reached, 20 ml of H₂O were added, and the mixture was heated to 150° C., heated at that temperature for 1 hour, and then cooled to room temperature. The resulting suspension was centrifuged at 13 000 rpm in a ThermoElektron Sorvall RC6 centrifuge. The sedimented ZnO powder was separated from 1,4-butanediol, redispersed twice in ethanol, and then dried in a drying cabinet at 50° C. for 5 hours.

The X-ray diffractogram of the powder obtained confirmed the formation of crystalline ZnO (FIG. 2). Calculation from the half-height width of the X-ray reflections gave an average crystal size for the primary particles of 40 nm. The ZnO powder showed an agglomerated microstructure with agglomerates in the micrometer range.

Process Step b)

Polycondensation of the ZnO Powder Prepared in Step a) with 1,4-Butanediol and Dimethyl Terephthalate

A 250 ml flask was charged with 58.6 g of 1,4-butanediol. 3.0 g of ZnO powder, prepared according to step a), were stirred into the 1,4-butanediol. The resulting 4.87% by weight suspension of ZnO in 1,4-butanediol was admixed with 0.89 ml of tetrabutyl orthotitanate and 97.1 g of dimethyl terephthalate. The mixture was heated to 250° C., in the same way as in step b) of example 1, and was heated at that temperature for 50 minutes. TEM analysis (FIG. 3) of the ZnO-filled polybutylene terephthalate obtained confirms the presence of substantially larger ZnO agglomerates than in example 1, in the range from about 2 to 6 μm.

1-23. (canceled)

24. A process for preparing polymer filled with nanoscale metal oxides, which comprises:
a) heating a suspension of one or more salts comprising the corresponding metals in a first polymerizable compound, to a temperature greater than the boiling point of water under process pressure and less than the boiling temperature of the first polymerizable compound and also less than the temperature at which the polymerization of the first polymerizable compound commences,
in the presence of water in an amount corresponding to 1 to 10 oxygen atoms per metal atom of the salt or of the salts comprising the corresponding metals, whereby a nanosuspension of one or more crystalline metal oxides, hydroxides or oxide hydroxides is obtained, and
b) polymerizing the first polymerizable compound under pressure and temperature conditions typical for the first polymerizable compound.

25. The process according to claim 24, wherein as salt or as salts one or more salts of monocarboxylic acids, especially of formic acid, acetic acid, propionic acid, stearic acid, acrylic acid and/or oleic acid and/or one or more salts of dicarboxylic acids, especially of oxalic acid, adipic acid, isopthalic acid and/or terephthalic acid, are used.

26. The process according to claim 24, wherein after step a) and before step b) secondary components which can disrupt the polymerization in step b) are separated off.

27. The process according to claim 24, wherein the polymerization of the first polymerizable compound in step b) takes place with addition of a second polymerizable compound.

28. The process according to claim 24, wherein the polymerization takes place with addition of typical additives.

29. The process according to claim 24, wherein step a) is carried out in the presence of water in an amount corresponding to from 2 to 4 oxygen atoms per metal atom of the salt or salts comprising the metals corresponding to the metal oxides, oxide hydroxides or hydroxides.

30. The process according to claim 24, wherein stage a) is carried out under atmospheric pressure.

31. The process according to claim 24, wherein the nanosuspension of one or more crystalline metal oxides, oxide hydroxides or hydroxides, prepared in stage a), comprises one or more of the following metals: zinc, titanium, cerium, zirconium, iron, cobalt, copper, and aluminum.

32. The process according to claim 24, wherein the concentration of one or more crystalline metal oxides in the nanosuspension prepared in stage a) is less than 50% by weight, based on the total weight of the nanosuspension.

33. The process according to claim 24, wherein the average particle size of the one or more crystalline metal oxides prepared in stage a) is in the range from 1 to 500 nm.

34. The process according to claim 24, wherein as a first polymerizable compound use is made of one or more compounds selected from styrene, caprolactam, and acrylates.

35. The process according to claim 27, wherein as a first polymerizable compound use is made of a diol and as second polymerizable compound use is made of one or more compounds selected from dicarboxylic acid compounds, diamino compounds, aminocarboxylic acid compounds, hydroxycarboxylic compounds, aminoalcohol compounds, and organic compounds comprising at least 3 hydroxy-primary or -secondary amino and/or carboxyl groups per molecule, and aliphatic or aromatic isocyanates.

36. The process according to claim 35, wherein the first polymerizable compound is a diol.

37. The process according to claim 35, wherein the second polymerizable compound is a dicarboxylic acid or a dicarboxylic acid derivative.

38. The process according to claim 36, wherein the diol is 1,4-butanediol, 1,2-ethanediol or 1,2-propanediol, 1,3-propanediol or a mixture thereof.

39. The process according to claim 36, wherein the diol is 1,4-butanediol.

40. The process according to claim 37, wherein the dicarboxylic acid is adipic acid or terephthalic acid.

41. The process according to claim 37, wherein the dicarboxylic acid derivative is a mono- or a diester of a dicarboxylic acid.

42. The process according to claim 41, wherein the dicarboxylic ester is dimethyl or diethyl adipate or dimethyl or diethyl terephthalate.

43. A polymer filled with crystalline nanoscale metal oxides and obtainable by a process according to claim 24.

44. The process according to claim 32, wherein the concentration of one or more crystalline metal oxides in the nanosuspension prepared in stage a) is less than 20% by weight, based on the total weight of the nanosuspension.

45. The process according to claim 44, wherein the concentration of one or more crystalline metal oxides in the nanosuspension prepared in stage a) is less than 10% by weight, based on the total weight of the nanosuspension.

46. The process according to claim 33, wherein the average particle size of the one or more crystalline metal oxides prepared in stage a) is in the range between 5 and 150 npm.
